(19) United States
(12) Patent Application Publication
(10) Pub. No.: US 2026/0338544 A1
(43) Pub. Date: Oct. 29, 2026

(54) X-RAY ROTATING ANODE ANALYSIS SYSTEM

(71) Applicant: PLANSEE SE, Reutte (AT)

(72) Inventors: Richard GREISEL, Reutte (AT); Thomas SCHWARZ, Reutte (AT); Jürgen SCHATTE, Reutte (AT); Michael MARK, Reutte (AT); Maximilian SILLER, Reutte (AT); Christian GROHS, Reutte (AT)

(21) Appl. No.: 18/997,239

(22) PCT Filed: Jul. 4, 2023
(86) PCT No.: PCT/AT2023/060211

§ 371 Date: Jan. 21, 2025

(30) Foreign Application Priority Data
Jul. 19, 2022 (AT) GM 50113/2022

(51) Int. Cl. G01B 11/24; G01B 11/06; G06T 7/00; H01J 35/10

(52) U.S. Cl. CPC G01B 11/24; G01B 11/0608; G06T 7/0002; H01J 35/10

(57) ABSTRACT

An X-ray rotating anode analysis system for analyzing a used X-ray rotating anode with a circumferential focal track on a surface section. The X-ray rotating anode analysis system has a positioning device for the X-ray rotating anode, an imagine recorder, and a data processor coupled to the imagine recorder. The positioning device and the imagine recorder are configured such that the X-ray rotating anode can be an individual component in a predetermined position relative to the imagine recorder. The imagine recorder and the data processor are configured to detect a three-dimensional elevation profile of the surface section in a region of its focal track by the imagine recorder and the data processor. From at least a part of the detected three-dimensional elevation profile, an expected radiant power or a characteristic variable thereof of the X-ray rotating anode can be determined by the data processor.

The present invention relates to an X-ray rotating anode analysis system for analysing a used X-ray rotating anode having a circumferential focal path on a surface portion thereof. Furthermore, the present invention relates to a method for analysing such a used X-ray rotating anode.

X-ray rotating anodes are built into X-ray tubes, which in turn are integrated into corresponding X-ray devices. The X-ray rotating anodes are used to generate X-rays, as explained below: During use, electrons are emitted from a cathode of the X-ray tube and accelerated in the form of a focussed electron beam onto the rotating X-ray anode. Due to the rotary motion of the X-ray rotating anode, the electron beam scans a ring-shaped path—the focal path. A large proportion of the energy of the electron beam is converted into heat in the X-ray rotating anode, while a small proportion is emitted as X-rays. The amount of heat released locally causes the X-ray rotating anode to heat up considerably. The rotation of the X-ray rotating anode counteracts overheating of the anode material.

High radiation outputs of the emitted X-rays are required particularly in the high-performance range, especially for medical imaging applications such as computer tomography. Each time the focal path material is moved under the electron beam due to rotation, the surface of the focal path in the area of the focal spot initially experiences a high temperature increase and thermally induced stresses, followed by a drop in temperature. This causes the focal path to age, which can be seen in the roughening of its surface, the formation of cracks, grain breakouts and/or localised melting.

The ageing of the focal path leads to a reduction in the emitted radiation power as well as to a deterioration in the stability of the operation of the X-ray tube. However, other effects, such as ageing of the cathode (emitter), wear in the area of the bearing components and/or distortion of the X-ray rotating anode also lead to such a reduction and/or deterioration. Assessing the causes of this is therefore a challenge. If the X-ray rotating anode is suspected or identified as a (co-)cause, the question of its further use arises. If the X-ray rotating anode is still functional, the options are immediate reuse, provided that the functionality can be restored, reconditioning (also known as “rework”; e.g. reworking the focal path, processing and reapplying the focal path, mechanical reworking in the area of the bearing components, etc.), or otherwise recycling the X-ray rotating anode. This decision is often made subjectively by individuals after a visual inspection of the X-ray rotating anode. From an ecological, sustainability and cost point of view, it is desirable to recycle X-ray rotating anodes that can be reused or reprocessed. The condition of the focal path is a key factor influencing the further use of the X-ray rotating anode.

An X-ray rotating anode test stand for the assessment of X-ray rotating anodes is known from the disclosure document CN 114428099 A, in which an X-ray rotating anode to be examined is placed in a vacuum chamber of the test stand, set in rotation and brought to operating temperature by means of an electron beam in the region of its focal path. The test stand also has a temperature sensor for detecting the temperature of the X-ray rotating anode and a control device which, among other things, evaluates the condition of the X-ray rotating anode depending on the heat supplied and the temperature detected.

Furthermore, the publication by Siller, Maximilian, et al. “Geometrical model for calculating the effect of surface morphology on total x-ray output of medical x-ray tubes.” Medical Physics 48.4 (2021): 1546-1556 describes a geometric calculation model that can be used to determine the effect of surface morphology on the emitted radiation output of medical X-ray tubes. In this publication, X-ray standing anodes were exposed to a pulsed electron beam in such a way that their surface morphology in the area of the focal spot corresponds to that of aged X-ray standing anodes and the 3-dimensional height profile of this surface was recorded using laser scanning confocal microscopy (LSCM). The geometric calculation model was used to determine a reduction in the emitted radiation power due to the surface structures contained in the 3-dimensional height profile compared to a smooth surface. Furthermore, the geometric calculation model was verified with experimental comparison values.

Accordingly, the task of the present invention is to provide an analysis system for used X-ray rotating anodes which have been removed from the respective X-ray tube, by means of which the condition of the respective X-ray rotating anode in the region of its focal path can be reliably and objectively assessed.

The problem is solved by an X-ray rotating anode analysis system according to claim 1 and by a method for analysing a used X-ray rotating anode according to claim 14. Advantageous further embodiments of the invention can be seen from the dependent claims, which can be freely combined with one another.

According to the present invention, an X-ray rotating anode analysing system for analysing a used X-ray rotating anode having a circumferential focal path on a surface portion thereof is provided. The X-ray rotating anode analysing system has a positioning device for the X-ray rotating anode, an image recording unit and a data processing unit coupled to the image recording unit. The positioning device and the image recording unit are designed in such a way that the X-ray rotating anode can be positioned as a single component (i.e., in a state removed from the X-ray tube) at a predetermined position relative to the image recording unit. The image recording unit and the data processing unit are set up in such a way that a 3-dimensional height profile of a surface section of the X-ray rotating anode in the region of its focal path can be recorded by the image recording unit and the data processing unit, and that an expected radiation power or a characteristic value of the expected radiation power of the X-ray rotating anode can be determined by the data processing unit from the recorded 3-dimensional height profile or from a part thereof.

The expected radiation power determined via the 3-dimensional height profile is a key criterion with regard to the expected performance of the X-ray rotating anode in general and the condition of the focal path in particular. The surface morphology of the focal path is a significant influencing factor on the emitted radiation power, as unevenness leads to local absorption effects of the emitted X-rays. The expected radiation output determined is therefore essential for the decision on the further use of the X-ray rotating anode in question. Based on the 3-dimensional height profile, further advantageous analyses are also possible, as explained with reference to further embodiments. The automated determination of the expected radiation output by the X-ray rotating anode analysis system represents a significant advantage, particularly in comparison to a visual assessment of X-ray rotating anodes by individuals, as it is objective and enables the inclusion of significantly more data and details. Compared to evaluation methods that are carried out on the X-ray rotating anode in its installed state in the X-ray tube, such as the direct measurement of the emitted radiation power and/or the evaluation of backscattered electrons, the X-ray rotating anode analysis system according to the invention has the advantage that the state of the focal path is recorded directly and the result of the analysis is not falsified by other influencing factors (e.g. ageing of the cathode, filters used, etc.). The X-ray rotating anode analysis system is a system that differs from an X-ray device or an X-ray tube; in particular, it does not have a vacuum flask or a unit for accelerating an electron beam onto the X-ray rotating anode. Finally, by using an appropriately equipped data processing unit, the present invention advantageously utilises the options of automated calculations, which enable the processing of large amounts of data. At the same time, the use of the image recording unit and the positioning device eliminates the need for expensive components, such as those used in other evaluation methods (e.g. when generating an electron beam, for spectral-dependent detection of backscattered electrons, etc.).

The “used X-ray rotating anode” does not form part of the claimed X-ray rotating anode analysis system; reference is only made to the former to describe the function and design of the X-ray rotating anode analysis system. The term “focal path” refers at least to the (annular) surface area of the X-ray rotating anode that is scanned by the electron beam when the X-ray rotating anode is in use. In many cases, X-ray rotating anodes have an annular coating (on a carrier body formed underneath) in this surface area and in any areas directly adjacent to it, which is specially designed for generating X-rays.

Suitable materials for the coating are in particular materials with a high atomic number, such as tungsten, tungsten-based alloys, in particular tungsten-rhenium alloys (e.g., with a rhenium content of up to 26 wt. %, preferably in the range of 5-15 wt. %, in practice typically in the range of 5-10 wt. %). In the latter case, the term “focal path” refers to the ring-shaped coating of the X-ray rotating anode. The design of X-ray rotating anodes defines an axial direction (along or parallel to the axis of rotation, to which the X-ray rotating anode is essentially rotationally symmetrical; also referred to as the z-direction), a circumferential direction (revolving around the axis of rotation, in the plane perpendicular to the axis of rotation) and radial directions, each of which extends away from the axis of rotation in the plane perpendicular to the axis of rotation (and ultimately spans the main plane of extension of the X-ray rotating anode). The x and y directions also run in this plane, with the y direction corresponding to the X-ray emission direction. The surface section, whose 3-dimensional height profile is recorded, can extend over or cover the entire circumferential focal path. However, it can also include only one or more partial areas of the same, in particular in the radial direction the area that is actually scanned by the electron beam (in particular with a radially wider focal path coating), and/or in the circumferential direction at least one sector or other section (e.g., rectangular). Preferably, the at least one partial area covered is then an area representative of the surface morphology of the focal path or, alternatively, the most severely damaged area, which can be assessed, for example, using a simple (e.g., only 2-dimensional) overview image of the focal path created at the beginning. As the focal path surface is typically curved and inclined to the main extension plane (this typically corresponds to the course of a truncated cone surface), appropriate corrections must be made in a known manner so that the heights of the individual image points are reproduced exactly relative to the ideal course of a (theoretically assumed) smooth focal path (i.e., a truncated cone surface) in the 3-dimensional height profile.

When determining the “expected radiation power”, the entire relevant (wavelength) spectrum of the X-ray radiation is included, as is the case in the practical use of X-ray rotating anodes. Furthermore, filtering typical in X-ray devices, which reduces the long-wave radiation component in particular, is also preferably applied in accordance with the operating conditions. The kinetic energy released in air (KERMA: kinetic energy released in matter) is preferably used as the decisive physical quantity for the radiation power. It is measured in the physical unit Gray (joule/kilogram) and indicates how much energy (in joules) is released per kilogram of matter (in this case air), whereby the entire relevant radiation spectrum (i.e., across all wavelengths) is added up. However, a deviating physical quantity characteristic of the radiation power can also be determined, which is correspondingly meaningful, e.g. a reduction in radiation power to be expected due to the surface morphology of the focal path, a ratio of the expected radiation power relative to a comparative radiation power of a smooth focal path surface, or a deviating definition/representation of the radiation power and/or the application of no or deviating filtering.

The positioning device is designed for positioning the X-ray rotating anode as a “single component”, i.e., in a state removed from the X-ray tube. In particular, the positioning device can engage or abut for positioning in a central opening/bore, on a centrally mounted stem, on a circumferential section and/or on an underside of the X-ray rotating anode opposite the focal path in the axial direction. In addition to contact and/or engagement, it can also be designed for fixing and, if necessary, additionally for rotating the X-ray rotating anode about its axis of rotation.

The positioning device, the image recording unit and the data processing unit can all be integrated into one and the same overall device. Alternatively, however, they can also be designed as separate units: it is then essential that the positioning device enables exact positioning of the X-ray rotating anode to be examined relative to the image recording unit (which is also possible, for example, by a corresponding mounting of the image recording unit relative to the positioning device). Furthermore, the coupling of the data processing unit to the image recording unit is essential, so that at least data (image data) can be transferred from the image recording unit to the data processing unit. In particular, they are in communication and data exchange with each other. The data processing unit itself can be fully integrated into the image recording unit, but it can also be fully or partially outsourced to at least one other device.

The use of the data processing unit means that this is a computer-aided method. The recording of the 3-dimensional height profile and the determination of the expected radiation power are carried out in particular according to (at least) one algorithm that can be executed by one or more appropriately configured software module(s). In other words, both steps are software-supported. The 3-dimensional height profile contains the associated height information for each image point (pixel) along the total area of the recorded surface section. In particular, it is a high-resolution 3-dimensional height profile that has been recorded and created. In particular, a resolution of ≤5 μm is used in all three spatial directions, preferably with a resolution of ≤4 μm. The resolution can be increased using special methods, in particular by recording a higher number of individual images by the image recording unit and processing the image data obtained accordingly. Achieving a high resolution is particularly advantageous in the vertical direction due to the shielding effects of surface structures (in practice, a resolution of up to ≤1 μm could be achieved in all three spatial directions). The expected radiation power can be determined from the entire recorded 3-dimensional height profile or only from partial information. As will be explained below with reference to further embodiments of the present invention, an area profile, for example, which covers only a partial area of the recorded surface section, or only one or more line profile(s) can be used as a basis.

According to a further embodiment, the image recording unit and the data processing unit are set up in such a way that, using electromagnetic radiation (in particular in the wavelength range of 10-3000 nm; nm: nanometres), several individual images can be created, each with different depth information of a surface section of the X-ray rotating anode to be analysed, and that a 3-dimensional height profile of the surface section to be analysed can be reconstructed from the individual images by the data processing unit. This is an efficient method for creating the 3-dimensional height profile, which can be realised cost-effectively, particularly due to the computer performance available to day and the low cost of the equipment. The electromagnetic radiation used can be composed of a spectrum of several wavelengths or alternatively be monochrome. Furthermore, the electromagnetic radiation used can also have a large coherence length of the waves (laser), in which case it is typically monochrome radiation. In principle, there are various possibilities known in the state of the art for creating the plurality of individual images and then creating the 3-dimensional height profile from them. Preferably, the image recording unit works according to the methods of optics. For example, the individual images can be captured from different angles and then combined to create the 3-dimensional height profile (photogrammetry method). Alternatively, it is possible, e.g. using the examination method of laser scanning confocal microscopy (LSCM), to gradually (preferably in steps of ≤0.5 μm, for example in steps of 100 nm; in modern devices, significantly smaller step widths can be set) adjust the focus of the optics (e.g., using a corresponding aperture) to different heights (e.g., perpendicular to the plane of the surface section to be analysed), and the sharply imaged partial areas can be recorded as individual images in order to then combine these individual images to form the 3-dimensional height profile.

According to a further embodiment, the image recording unit and the data processing unit are set up in such a way that, in particular using electromagnetic radiation in the wavelength range of 380 nm-780 nm (this corresponds to the visible range for the human eye), several individual images of the surface section to be analysed can be created from different angles. By varying the recording directions, corresponding depth information (in the axial or z-direction) can be obtained. Furthermore, the angle of illumination of the surface section is also preferably varied-either together with the exposure direction or independently of the respective exposure direction- and the shadow cast by the surface structures of the surface section to be analysed is also evaluated. In particular, “white” light, which covers a spectrum over this wavelength range, can be used.

In this way, the image recording unit (camera) can work with the methods of (light) optics and record the high-resolution individual images in an efficient and cost-effective manner. In particular, the image recording unit records the individual images with a corresponding magnification (e.g., in the range of 5-20×, in particular 10×). The 3-dimensional height profile can then be created from the individual images taken from different angles (number ≥2). The principle here is that the resolution of the 3-dimensional height profile created from the surface section to be analysed can be increased with the number of individual images taken from different angles. Accordingly, the number of individual images of a surface section to be analysed taken from different angles is preferably ≥20, even more preferably in the range of 50-100. Accordingly, this principle also applies if the alternative variant, in which the focus is set in steps (preferably in steps of ≤0.5 μm, for example in steps of 100 nm) to different heights and the sharply imaged partial areas are taken as individual images, in which case a number of ≥200, in particular ≥500 individual images is preferred. If a step width of 100 nm is set and a height range of, e.g., 100 μm is to be covered, this corresponds to, e.g., 1000 individual images.

According to a further embodiment, the data processing unit is set up in such a way that the expected radiation power or the characteristic value of the X-ray rotating anode can be determined based on an automatically calculated absorption of X-rays along an X-ray emission direction, taking into account local absorption effects due to local surface modifications or surface structures according to the recorded 3-dimensional height profile. The advantage of this further embodiment is that not only one or a few individual physical quantities characteristic or descriptive of the surface morphology as a whole, such as a mean roughness value Rₐ or a square roughness R_{q}, are used, but that the absorption of each (local) surface modification (elevation, crack, grain breakout, local melting, etc.) located in the analysed surface section is determined and thus its effect on the expected radiation output is taken into account. This also enables additional analysis options, such as the determination of serious local damage (e.g. large cracks or grain breakouts) and/or fluctuations in the expected radiation output occurring in the circumferential direction, which-even with an otherwise acceptable surface morphology of the surrounding surface areas of the focal path—can lead to a deviating assessment of the X-ray anode. This determination is carried out in particular with computer support (i.e., in particular by means of the data processing unit) using a corresponding algorithm, which can be executed by one or more appropriately equipped software module(s). The consideration of all local absorption effects (i.e., for example, for each image point or pixel or for each coordinate of an included surface section or line profile) is made possible by the computer performance available today. The so-called “X-ray emission direction” is determined by the geometry of the respective X-ray rotating anode. Typically, the section of the X-ray rotating anode on which the focal path is formed corresponds to the lateral surface of a truncated cone, whereby this lateral surface is inclined relative to the radial direction (in relation to the axis of rotation) by an angle of inclination (of e.g.) 10°. The X-ray radiation exit direction in the respective X-ray device generally runs exactly along the radial direction, so that it is inclined by the angle of inclination (of e.g.) 10° relative to the lateral surface and thus to the surface of the focal path (approximated locally as a plane).

According to a further embodiment, the data processing unit is set up in such a way that it can be used to automatically calculate the absorption of X-rays using at least one line profile which extends in the X-ray emission direction over a predetermined minimum length along the detected surface section of the X-ray rotating anode and has local surface modifications or surface structures according to the 3-dimensional height profile. By selectively using one or more line profile(s) according to this further embodiment, the required computer performance can be reduced. Each line profile represents the elevation profile according to the 3-dimensional elevation profile along the specified course direction. The respective line profile should extend in the X-ray emission di rection at least over the expansion length of the focal spot along the detected surface section of the X-ray rotating anode in this direction. This minimum length must be used because—as is known—the electron beam is not focussed exactly on one point on the X-ray rotating anode but has a finite extension (i.e., the focal spot) on the focal path surface with a certain electron intensity distribution (see Rolf Behling “Modern Diagnostic X-Ray Sources”, 2nd edition, 2021, pp. 226-231). For the focal spot, a focal spot size specific to the respective X-ray tube in which the X-ray rotating anode is used (if known) or a generally common focal spot size and electron intensity distribution on the focal path surface can be assumed (e.g. in the range of 4-12 mm, in particular e.g., 10 mm, maximum expansion in at least one direction; if necessary, however, only a partial area with the highest electron intensity can be used). Furthermore, it should be explained: due to the typically provided angle of inclination of the focal path (formed on the lateral surface of a truncated cone) relative to the X-ray emission direction (which typically corresponds exactly to the radial direction), the line profile results from a projection (along the axial direction) of the X-ray emission direction onto the detected surface section, which is expressed above by the formulation “in the X-ray emission direction over a predetermined minimum length along the detected surface section”. As explained below in relation to simplification/approach No. 2, the use of such line profiles and the approximation of the focal spot as a linear, appropriately adjusted intensity profile is particularly advantageous for X-ray rotating anodes due to the high-speed rotation that takes place during use.

According to a further embodiment, the data processing unit is set up in such a way that it can be used to automatically calculate the absorption of X-rays using at least one surface profile which extends in the X-ray emission direction over a predetermined minimum length and essentially perpendicular to this over a predetermined minimum width along the detected surface section and has local surface modifications according to the 3-dimensional height profile. The inclusion of at least one surface profile has the advantage that all surface modifications located on the included surface are included in the calculation. Each surface profile shows the height profile according to the 3-dimensional height profile for each pixel within the included surface. The above explanations on the length and course of the line profile apply accordingly to the minimum length and its course. With regard to the width, the included surface can in particular be sec tor-shaped (i.e., the inner and outer sides each run in the circumferential direction, with the inner side having a smaller extension than the outer side). However, other shapes of the surface profile are also possible.

Both in the further embodiment relating to the line profile and in that relating to the surface profile, only a single (e.g., representative) line or surface profile, which only picks out one line or one surface section of the focal path, can be used for the determination. In particular, several line or area profiles, preferably evenly distributed over the circumferential focal path in the circumferential direction, are used. They can also cover or encompass the entire circumferential focal path.

According to a further embodiment, the data processing unit is set up in such a way that at least one of the following input variables is included in the automated calculation of the absorption of X-rays:
Generation depth (in the focal path) of X-rays, which correlates with the penetration depth of electrons into the focal path to be analysed;
X-ray emission angle;
Material of the X-ray anode focal path;
Size of the focal spot;
Electron intensity distribution of the focal spot; and
Filter.

By taking these input variables into account, the accuracy and reliability of the determination of the expected radiation power is increased. The penetration depth of electrons into the focal path to be analysed is basically an intensity distribution over the depth, which depends on the acceleration voltage of the electrons. Accordingly, the correlated generation depth of X-rays is also an intensity distribution (which does not correspond exactly to the intensity distribution of the penetration depth of electrons due to absorption effects, among other things). To simplify matters, however, an average value of e.g. 1.6 μm (μm: micrometre) can be used for the generation depth of X-rays at an assumed acceleration voltage of e.g. 100 kV (kV: kilo-volt) (literature values are in the range of 1.0-1.6 μm). The X-ray emission angle corresponds to the angle of inclination explained above (which is usually 10° or even) 7° and—based on the assumed generation depth of X-rays—it must be taken into account when determining the path length of the generated X-rays through the material of the focal path and the associated (material-dependent) absorption of X-rays. Depending on the material of the focal path of the X-ray rotating anode and depending on the assumed acceleration voltage of e.g. 100 kV (kV: kilo-volts), the X-ray radiation spectrum generated can be determined (available from publicly accessible sources). Furthermore, the absorption of the generated X-rays until they emerge from the surface of the focal path depends on the material of the focal path (as well as on the respective wavelength of the X-ray spectrum), which is why the material of the focal path is preferably taken into account when determining the radiation power. With regard to the size and electron intensity distribution of the focal spot, the above explanations apply (depending on the calculation method, they can be specified as an intensity distribution over a surface or as a linear intensity distribution with a corresponding size in each case). Furthermore, filtering is used in X-ray devices (e.g., by borosilicate glass, which is used as a component in the radiation path, and/or aluminium or copper as specific, wavelength-dependent filters; both are collectively referred to as “filters” or “filtering”). Specific, wavelength-dependent filters (e.g., made of aluminium or copper) are used to reduce the proportion of long-wave radiation (also known as “soft” radiation), as this makes little or no contribution to imaging and leads to unnecessary radiation exposure. Accordingly, the wavelength-dependent filtering by such filters typically used in X-ray devices (e.g., 2.5 mm borosilicate glass and 2 mm aluminium filtering) is preferably included in the determination of the expected radiation output.

According to a further embodiment, the data processing unit is set up in such a way that it can be used to recognise and categorise damage to the focal path of the X-ray rotating anode in the area of the surface section from the recorded 3-dimensional height profile or from otherwise recorded image information of a surface section of the focal path. In addition to determining the expected radiation output, the detection and categorisation of damage, e.g. according to its type, such as roughening, local melting, crack, grain breakout, and/or according to its severity, e.g. height/depth, lateral expansion, etc., is another important criterion for assessing the condition of the focal path and is therefore helpful for issuing a further recommendation for use of the X-ray rotating anode in question. According to a further embodiment, the individual images taken from different angles of a surface section to be analysed form the basis for creating the image information captured elsewhere. In particular, each image point can be assigned a coordinate (in all three spatial directions), an RGB value (R: red component, G: green component, B: blue component of the additive colour space), a B/W value (B: black component, W: white component with regard to greyscale representation) and, if necessary, other information can also be assigned. Based on this, different 2-dimensional contrast representations of the analysed surface section can be created, from which-individually as well as in combination of several such contrast representations-damage to the focal path of the X-ray rotating anode in the area of the surface section can be recognised and categorised particularly well. In addition, the image information captured in other ways can also be derived from the 3-dimensional height profile (e.g., representation of the minimum and maximum heights, etc.) or formed by an image captured separately with a special camera setting or derived from this. For example, cracks that extend deep into the material of the focal path or even extend through the entire focal path coating and/or localised melting that leads to clearly raised melting beads on the surface of the focal path can be an indication that the focal path needs to be reworked to a considerable extent (e.g., by removing a significant proportion of the focal path or even the entire focal path coating and by reapplying focal path material) and that not only superficial grinding is sufficient.

Such automated recognition and categorisation is particularly software-supported. In particular, the software can be designed and set up in such a way that it learns or has previously learned this recognition and categorisation through machine learning. As part of this machine learning, the software is trained in particular by a skilled person identifying and categorising (“labelling”) damage in corresponding example images (e.g. the 3-dimensional height profile or other image information of a surface section of the focal path), whereby the software is given access to the example images and their identification and categorisation. The software is set up in such a way that it recognises and learns patterns from the sample images using a learning strategy. The quality of the recognition and categorisation by the software increases with the number and quality of the example images provided and thus “labelled”. Furthermore, a suitable representation of the relevant surface section can also facilitate recognition and categorisation, which is why it can also be carried out on the basis of image information acquired elsewhere.

According to a further embodiment, the image recording unit and the data processing unit are set up in such a way that the image recording unit and the data processing unit can record at least one image of a further surface section of the X-ray rotating anode in the area next to its focal path. This allows additional conclusions to be drawn about the quality of the other areas of the X-ray rotating anode, which may be located, for example, on the same side of the focal path (top side) or—viewed in the axial direction-on the opposite side of the focal path (rear side). As described above, a 3-dimensional height profile or other recorded image information can also be generated from the at least one image recording in order to carry out further analyses.

According to a further embodiment, the data processing unit is set up in such a way that further utilisation options of the X-ray rotating anode can be evaluated by it based on the determined, expected radiation output or based on the characteristic value for this and a corresponding utilisation recommendation can be issued (e.g. via a display or a display unit of the data processing unit). In this way, the issued recommendation for use is based on an objective assessment of the X-ray rotating anode, taking into account the condition of the focal path, so that in particular those X-ray rotating anodes that can be directly reused or restored by reprocessing (also known as “rework”) can also be put to such a resource-saving further use. In addition to the expected radiation output, other criteria, such as damage to the focal path or the condition of other areas of the X-ray anode, can also be included in the assessment. In particular, a further recommendation for use may include one or more of the following options:
direct further use of the X-ray anode,
superficial sanding of the focal path surface,
localised repair of the focal path in the area of severe damage (e.g., localised removal and reapplication of focal path material),
large-scale mechanical removal of the entire focal path material (in particular the entire focal path coating) or a corresponding surface area, subsequent application of focal path coating and optionally subsequent smoothing (e.g., by grinding) of the applied focal path material,
mechanical reworking of the X-ray rotating anode outside the focal path area (e.g. in the area of the axial mounting, to eliminate imbalances, etc.),
Recycling of the X-ray rotating anode (in the event of irreparable damage).

In the case of direct reuse or after reprocessing, the further use recommendation May also include the recommendation of specific operating conditions (e.g. operation with certain parameters or in certain X-ray tubes or X-ray devices).

According to a further embodiment, the data processing unit is coupled to a memory unit, which can in particular be distributed on a single device/memory or alternatively also on several devices/memories (in particular they are in communication connection and in data exchange with each other) and the data processing unit and the memory unit are set up for at least one of the following interactions:
Information determined individually for the respective analysed X-ray rotating anode can be stored in the memory unit by the data processing unit and read out from the memory unit (individualisation, e.g. by automated recognition of a serial number of the X-ray rotating anode),
e.g., recorded 3-dimensional height profiles, line profiles, surface profiles, individual images, otherwise recorded image information, damages, in each case from the area of the focal path and/or next to the focal path,
the determined, expected radiation power,
an issued recommendation for further use, etc.;
Type-specific information for different types of X-ray rotating anodes can be stored in the memory unit by the data processing unit and can be read out from the memory unit,
such as drawings, structure (including connection technologies used, coatings, etc.), manufacturing data (e.g. also unique identification number assigned to each X-ray rotating anode during manufacture), transport data, dimensions of X-ray rotating anodes, materials of X-ray rotating anodes (in particular the focal path, an anode disc formed underneath, etc.), etc.;
The data processing unit is able to store and read out from the memory unit individually recorded operating data for the respective analysed X-ray rotating anode, e.g., load cycles, operating times, rotation speeds, applied acceleration voltages between cathode and X-ray rotating anode, cathode type, size and electron intensity distribution of the focal spot, etc.; and
The individual history of each analysed X-ray rotating anode regarding its use in the field (i.e., in X-ray devices) and regarding revisions and modifications made to it (such as those made after analysis in an X-ray rotating anode analysis system over the life cycle) can be stored in the memory unit and read out from the memory unit.

In this way, the entire “life history” of an X-ray rotating anode can be tracked and documented by the X-ray rotating anode analysis system. In particular, the data is stored together with the relevant date (“date stamp”). Based on this data, it is then possible to make better predictions/recommendations regarding further utilisation options when analysing a specific X-ray rotating anode. This is sometimes summarised under the keyword of life cycle management.

According to a further embodiment, the data processing unit is set up in such a way that at least one of the following further pieces of information is included in the evaluation of the further utilisation options of the X-ray rotating anode:
Homogeneity of the 3-dimensional height profile along a circumferential direction of the X-ray rotating anode;
Damage to the focal path of the X-ray rotating anode in the area of the surface section;
Image of another surface section of the X-ray rotating anode in the area next to its focal path;
Geometric changes to the X-ray rotating anode (e.g. can be determined by 3-dimensional measurement of the X-ray rotating anode, in particular tactilely using a sensor that scans the external dimensions of the X-ray rotating anode, for example);
Information determined individually for the respective X-ray rotating anode analysed;
type-specific information for the respective X-ray rotating anode analysed;
individual operating data collected for each X-ray rotating anode analysed; and
individual history of the analysed X-ray rotating anode.

The inclusion of at least one of these additional pieces of information improves the quality of the assessment of further utilisation options. For example, the need for local repairs can be derived from a strong inhomogeneity of the 3-dimensional height profile along the circumferential direction. In the case of geometric changes, imbalances that occur, an increase in the outer diameter and/or an enlargement of a central mounting hole (in the case of X-ray rotating anodes without an integrally formed stem) are particularly critical. In particular, the need for mechanical reworking or, if the extent is too advanced, the measure of recycling the X-ray rotating anode can be derived from this.

Furthermore, the remaining service life of the X-ray rotating anode in question can also be estimated on this basis. This leads to an improvement in the overall life cycle management of X-ray rotating anodes. Even further, measures for improving future X-ray rotating anodes can be derived from the data collected, such as design adjustments, optimisation of the connection technology (e.g. by soldering, welding, etc.), and/or application of coatings.

In principle, the present invention relates to the X-ray rotating anode analysis system without the respective X-ray rotating anode to be analysed. According to a further embodiment, an X-ray rotating anode (to be analysed) is accommodated as an individual component in the positioning device. This corresponds to the operational state of the X-ray rotating anode analysis system. In particular, the positioning device is designed in such a way that the X-ray rotating anode can be positioned exactly relative to the image recording unit. This can be done in the simplest way by means of a corresponding (preferably adjustable) stop. It is preferable that the positioning device enables the X-ray rotating anode to be positioned in at least two spatial directions (e.g. perpendicular to the axis of rotation), in particular in all three spatial directions (in particular by means of appropriately provided fixing elements), at least by means of positive locking, and even more preferably additionally by means of frictional locking. Furthermore, it is preferable that the positioning device allows the X-ray rotating anode to be rotated about the axis of rotation by a (preferably adjustable) angle of rotation after a first fixation in order, for example, to examine different sections of the focal path.

The present invention further relates to a method of analysing a used X-ray rotating anode having a circumferential focal path on a surface portion thereof. The method comprises the following steps:
Positioning of the X-ray rotating anode as a single component with the aid of a positioning device relative to an image recording unit;
Acquisition of a 3-dimensional height profile of a surface section of the X-ray rotating anode in the region of its focal path by the image recording unit and by a data processing unit coupled to the image recording unit; and
Automated determination of an expected radiation power or a characteristic value of the X-ray rotating anode by the data processing unit from the recorded 3-dimensional height profile or from a part thereof.

The steps of acquiring the 3-dimensional height profile and the automated determination of the expected radiation power are carried out in particular according to (at least) one algorithm that can be executed by one or more appropriately configured software module(s). This means that both steps are software-supported. In particular, the at least one software module is stored in the data processing unit or on a separate memory in such a way that it can be loaded into the data processing unit and executed on the latter. The method according to the invention achieves essentially the same advantages as the X-ray rotating anode analysis system according to the invention. Furthermore, the further developments and variants explained above are possible in a corresponding manner, whereby the features explained on the device side can in particular also be carried out or are carried out as corresponding process steps by the units/components mentioned in each case. In particular, the method according to the invention is carried out with the X-ray rotating anode analysis system according to the invention, whereby one or more of the above-mentioned further developments/variants can also be realised.

Further advantages and functionalities of the invention are shown in the following description of embodiments with reference to the attached figures.

### FIGURE DESCRIPTION

The FIGURES show

FIG. 1: A schematic representation of an X-ray tube in longitudinal section;

FIG. 2: A perspective view of an X-ray rotating anode;

FIG. 3: A perspective view of another X-ray rotating anode in cross-section;

FIG. 4: a schematic representation of an X-ray rotating anode analysis system according to the present invention;

FIG. 5: An exemplary 3-dimensional height profile for a focal path surface;

FIG. 6: Illustration of the calculation of the path length of the generated X-rays through the focal path material for a perfectly smooth focal path surface;

FIG. 7: Illustration of the calculation of the path length of the generated X-rays through the focal path material for a focal path surface with surface structures;

FIG. 8: Three diagrams showing at the top (first diagram) an exemplary line profile of a used focal path surface, below (second diagram) the resulting additional path length distribution, and again below (third diagram) the resulting emission distribution.

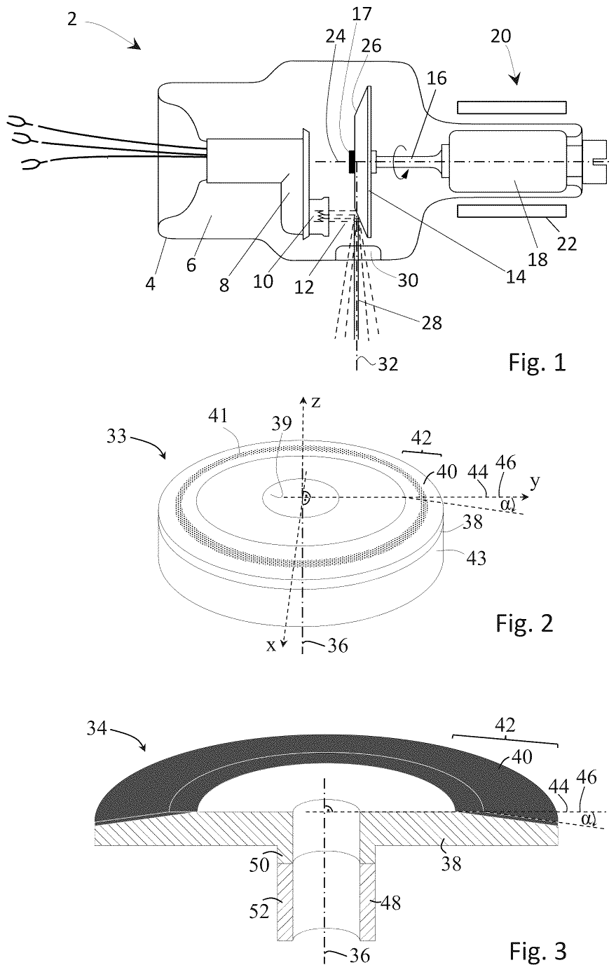

FIG. 1 shows a schematic longitudinal section of an X-ray tube 2. It has a glass bulb 4 with a vacuum interior 6, in which there is a cathode 8 with a heating coil 10, which emits electrons 12 when in use (i.e., when current is flowing). An X-ray rotating anode 14 is arranged opposite the cathode 8. The X-ray rotating anode 14 has a central mounting hole to which a stem (shaft) 16 is attached by means of a fixing 17. The shaft 16 connects the X-ray rotating anode 14 to a rotor 18 of an electric motor 20. The electric motor 20 has a stator 22 outside the glass bulb. When in use, the electric motor 20 causes the X-ray rotating anode 14 to rotate about an axis of rotation 24 in a known manner. The electrons 12 emitted by the cathode 8 are accelerated onto a rotating focal path 26 of the X-ray rotating anode 14. When they hit the focal path 26, their kinetic energy is converted into heat and, to a lesser extent, into X-rays 28. Through an exit window 30, which may for example be formed from a borosilicate glass and serves to extract the X-radiation from the X-ray tube, a portion of the generated X-radiation 28 is extracted in an X-ray emission direction 32 which is perpendicular to the axis of rotation 24. In addition, further filters, such as those made of aluminium or copper, are typically also used in the beam path of the X-rays in order to reduce the proportion of long-wave (soft) X-rays. The extracted X-rays are then used in an X-ray machine to radiate through an object, for example for diagnostic imaging in a medical X-ray machine.

The structure of a X-ray rotating anode 33 is explained below using FIG. 2 as an example. In its basic form, this has a anode disc 38 with a central mounting hole 39 that is rotationally symmetrical to a axis of rotation 36 (axial direction or also z-direction). In particular, the anode disc 38 is made of a molybdenum-based material (with ≥50 wt. %, in particular ≥90 wt. % molybdenum) or of pure molybdenum. On one side of the anode disc 38, the cover side, there is a circumferential focal path 40 with a focal path coating made of a tungsten-rhenium alloy (tungsten: 95 wt. %; Re: 5 wt. %). The circulating area on the focal path 40 shown as a dotted line in FIG. 2 visualises the focal spot path 41, i.e. the ring-shaped area that is scanned by the electron beam (focal spot) during the rotation of the X-ray rotating anode 33. In the area of the focal path 40, the anode disc 38 has a circumferential bevelled focal path surface 42. It is angled at an inclination angle α (in the present case: α=10°) relative to a main extension plane 44 extending perpendicular to the axis of rotation 36, which is spanned by the radial directions and is also referred to as the xy plane in the present case. The course of the focal path surface 42 corresponds to the lateral surface of a truncated cone. In each case, the circumferential direction extends locally perpendicular to the radial directions around the axis of rotation 36. The X-ray emission direction 46 generally runs exactly along one of the radial directions, so that it is inclined by the angle of inclination α (of e.g. 10°) relative to the focal path surface 42. In the rectangular coordinate system used for the description, which is spanned by the x-, y- and z-axes, the y-axis runs along the X-ray radiation exit direction 46 (whereby this is only shown as an example in FIG. 2 and is defined in the X-ray tube by the position of the exit window), the x-axis runs perpendicular to this within the main extension plane 44, and the z-axis runs in the axial direction (as shown schematically in FIG. 2). On the rear side (i.e. opposite the cover side), a graphite body 43 is attached (in particular soldered) to the anode disc 38.

FIG. 3 shows a further embodiment of a X-ray rotating anode 34, whereby the same reference symbols are used for identical or corresponding components/sections as for the X-ray rotating anode 33 of FIG. 2 and only the differences are discussed below, while reference is also made to the figure description of FIG. 2. A graphite body is not provided in the X-ray rotating anode 34 of FIG. 3. Furthermore, it has an integrally formed stem 48 on the rear side, which in the schematic illustration shown is composed of a socket 50 formed monolithically with the anode disc 38 and a tubular component 52 connected to it (e.g., by welding). The tubular component 52 can also have further mechanical connection elements at its distal end for attachment to other components (such as a rotor).

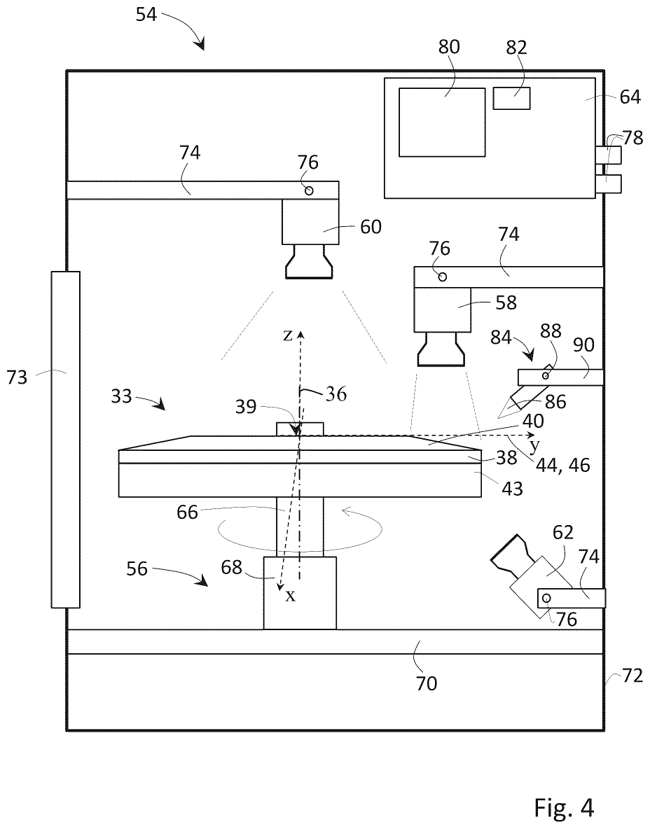

FIG. 4 shows a schematic diagram of a X-ray rotating anode analysis system according to the invention 54. It has a positioning device 56, described in more detail below, an image recording unit 58, additional image recording unit 60, 62 and a data processing unit 64. The positioning device 56 is designed to receive and precisely position X-ray anodes of different designs, in particular with or without an integrally provided stem. In the present case, an exemplary X-ray rotating anode 33, which essentially corresponds to that of FIG. 2 and for whose components/sections the same reference symbols are used accordingly, is firmly mounted with its fastening hole 39 on a shaft 66 of the positioning device 56. The shaft 66 can be set in rotation via a rotation device 68, which is motorised in the present case and can be controlled via the data processing unit 64, so that the rotational position of the X-ray rotating anode 33 relative to the image recording unit 58 (and the additional image recording units 60, 62) can be adjusted. Furthermore, the shaft 66 is mounted on a carrier component 70 via the rotation device 68. The carrier component 70 is in turn connected to a (schematically indicated) frame structure 72 of the X-ray rotating anode analysing system 54 in order to enable exact positioning of the X-ray rotating anode 33 relative to this frame structure 72 (and thus to the image recording units 58, 60, 62).

Accordingly, the image recording units 58, 60, 62 are also connected to the frame structure 72 via support 74 in such a way that their position and tilt (see joint 76) can be adjusted precisely relative to the frame structure 72 (and thus relative to the X-ray rotating anode 33). The image recording unit 58 (as well as the additional image recording units 60, 62) is also in communication with the data processing unit 64. The image recording unit 58 can be controlled via the data processing unit 64 in order to record individual images of a surface section of the X-ray rotating anode 33 to be analysed, in particular a surface section in the region of the focal path 40 of the X-ray rotating anode 33. The image recording unit 58 is formed by a high-resolution camera (which preferably operates in the optically visible range) with a magnification in the range of 5-20× and with a lateral resolution (in the xy plane, in relation to the spatial directions defined in FIG. 2 and also drawn in FIG. 4) of ≤4 μm. In particular, the camera has a lateral resolution along the xy plane of the surface section of 3.355 μm and a vertical resolution in the z direction of 3.565 μm and a magnification of 10× is set, whereby the resolution can be increased by a high number of individual images. Preferably, a separate illumination unit is provided, in particular with variably adjustable positioning (e.g., an LED with “white” light, i.e., which preferably covers a spectrum over essentially the visible wavelength range). In addition, or alternatively, the camera has an internally designed illumination unit (e.g., an LED with “white” light, i.e., which preferably covers a spectrum over essentially the visible wavelength range). The same preferably applies to the further image recording units 60, 62, whereby these can, for example, be designed and positioned such that an image recording unit 60 can record an image of a larger section of the cover side (or also the entire cover side) of the X-ray rotating anode 33 and/or that an image recording unit 62 can also record an image of a larger section of the rear side (or also the entire rear side) of the X-ray rotating anode 33.

The control of and communication with the image recording unit 58 and with other system components of the X-ray rotating anode analysis system 54, in particular with the additional image recording units 60, 62, the rotation device 68, the tactile measuring device 84 described below, etc., is carried out by the data processing unit 64 via interfaces 78 (schematically indicated in FIG. 4). Furthermore, the data processing unit 64 has a input and display unit 80, via which a user can make inputs (input of information, triggering of actions, etc.) and have corresponding information (results, recommendations, prompts, etc.) displayed, as well as a memory unit 82, in which data can be stored via the data processing unit and can in turn be read out from it.

The individual images are preferably recorded in such a way that the rotation device 68 further rotates the X-ray rotating anode 33 in each case by predetermined feed angles (for example by an angle in the range of 1-2° in each case) about the axis of rotation 36, in order to create individual images of a surface section of the focal path 40 to be analysed (i.e. individual images of the surface sections which are in each case located under the recording area of the image recording unit 58, so that the individual surface sections overlap several times in each case) by the image recording unit 58 at each of these different angular positions. In parallel, individual images can also be created by the additional image recording units 60, 62 (at each or alternatively only at selected angular positions). Furthermore, a tactile measuring device 84 is shown in FIG. 4, which has a sensor 86, which is mounted on a support 90 with an angular position that can be variably adjusted via a joint 88 and is in turn connected to the frame structure 72 via this. The X-ray rotating anode 33 can be measured tactilely by the tactile measuring device 84 (possibly also during a rotation of the same) in order to determine any geometric changes of the X-ray rotating anode 33 that may have occurred.

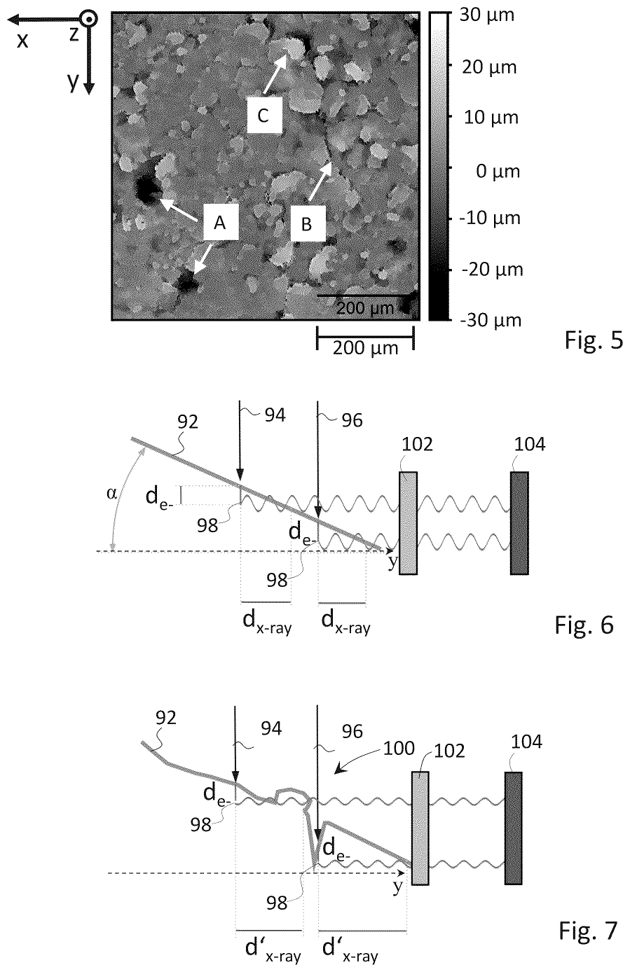

In the following, with reference to FIGS. 5 to 8, an exemplary embodiment for calculating the absorption of X-rays along an X-ray emission direction is described, taking into account local absorption effects due to local surface modifications according to a recorded 3-dimensional height profile, in order to then determine a characteristic value of the expected radiation power. Additional information and literature on the simplifications made and the approach to this calculation can be found in Siller, Maximilian, et al. “Geometrical model for calculating the effect of surface morphology on total x-ray output of medical x-ray tubes.” Medical Physics 48.4 (2021): 1546-1556. In order to be able to carry out this calculation automatically, software is provided in particular by which the calculation can be carried out according to a corresponding algorithm and can be loaded into the data processing unit (for example into the data processing unit 64 shown in FIG. 4) and executed thereon.

FIG. 5 shows an example of a 3-dimensional height profile M_{height}(x,y) of an analysed surface section, as is typical, for example, for aged focal paths of X-ray rotating anodes after their use in X-ray devices (reference is made to the coordinate system defined in FIGS. 2 and 4). Each image point or pixel in the xy plane of this 3-dimensional height profile is assigned a corresponding height value or z value, whereby this is represented by the grey scale representation. The z range shown ranges from −30 μm in the negative range (shown in black) to 0 μm (shown in grey) to +30 μm in the positive range (shown in white) (μm: micrometres). FIG. 5 also shows typical damage to the focal track surface that occurs after prolonged use. Two crater-shaped indentations labelled “A” can be seen in the lower left part of the profile. These are grain breakouts in the focal path material. In the right-hand half, a narrow depression can be seen that extends essentially vertically across the centre part of the image and is labelled “B”. This is a crack in the focal path material. Furthermore, a bead-like elevation, labelled “C”, can be seen in the upper right part, which is a local melting. Such a 3-dimensional height profile-regardless of its specific shape and the specific height profile-forms the starting point for calculating the absorption of X-rays along the X-ray emission direction.

The calculation according to the present embodiment is based on the concept that for each generation point of X-rays (corresponding to the generation depth of X-rays in the z-direction below the focal path surface), the absorption of the generated X-rays by the focal path material is determined taking into account the local surface modifications according to the 3-dimensional height profile and then-insofar as the X-rays are directed along the X-ray emission direction—is summed up or integrated over all relevant generation points (in the present case: of a line profile). The X-ray radiation emitted at each generation point in the X-ray emission direction (“initial spectrum”) is based on the characteristic X-ray spectrum (braking radiation distribution with characteristic lines) for the respective focal path material as a function of the acceleration voltage (in this case 100 kV). Data and calculation methods for typical acceleration voltages and focal path materials are available in the literature (to simplify matters, pure tungsten can be used for tungsten-rhenium alloys with a predominant proportion of tungsten due to their similar atomic number and density). Furthermore, it must be taken into account that only those individual image points or pixels of the 3-dimensional height profile (or in the present case: a line profile derived from it) are to be included that lie within the focal spot area of the X-ray rotating anode, and these are then to be weighted according to the electron intensity distribution, whereby this only takes place as one of the last steps in the present calculation model. In this example, the calculation is carried out for a line profile of a surface section of the focal path to be analysed, assuming that electrons are accelerated with an acceleration voltage of 100 kV to this section with a typical size and intensity distribution of the focal spot.

According to the present embodiment, the following simplifications/approaches are used:
1. For simplification purposes, an average generation depth dₑ₋ of X-rays is used and not an actual distribution of the generation depths along the z-axis (the latter would mean several generation points along the z-coordinate for each xy-coordinate according to the distribution function and would require summing up or integrating over these generation points). In other words, according to this simplification, exactly one generation point with a z-coordinate de-below the focal path surface is assumed for each image point or pixel with an associated xy-coordinate in the z-direction. Average generation depths as a function of the surface tension applied between the cathode and the X-ray anode in e.g. tungsten-based focal path material can be found in the literature. For example, for an accelerating voltage of 100 kV, an average generation depth dₑ₋ of X-rays in tungsten-based material of 1.6 μm is given in Poludniowski, Gavin G., and Philip M. Evans. “Calculation of x-ray spectra emerging from an x-ray tube. Part I. Electron penetration characteristics in x-ray targets.” Medical physics 34.6 Part1 (2007): 2164-2174 cited (further relevant source: Behling, Rolf. “Modern diagnostic x-ray sources: technology, manufacturing, reliability”. CRC Press, 2021, p. 71).
2. With regard to the size and electron intensity distribution of the focal spot:

Compared to a static arrangement of a focal spot on a focal path surface (see for example standing anodes), where an electron intensity distribution over the affected area (x,y coordinates) of the focal spot must be taken as a basis, an X-ray rotating anode can be based on a linear (along the X-ray emission direction or y-direction) and correspondingly adapted intensity profile due to the rotation in use. For example, this can be determined using X-ray rotating anodes and in many cases (depending on the type of cathode) can be approximated by two overlapping sinusoidal functions (in many cases the intensity distribution is formed by an elevation that has two overlapping “humps” in the y-direction). Alternatively, it can also be simulated by including the electromagnetic interactions for different cathode types, as required.

Regarding the 3-dimensional height profile: Accordingly, a comparison of the radiation power emitted by an aged focal path surface with surface structures with the radiation power emitted by a perfectly smooth focal path surface does not require a two-dimensional view of the recorded 3-dimensional height profile and a corresponding application of surface functions (with x and y coordinates) (cf. e.g. the approach taken in the above-mentioned publication by Maximilian Siller et. al with regard to standing anodes), but it is sufficient if corresponding line profiles of the 3-dimensional height profile running in the radial direction are used and compared with each other (which point in the X-ray emission direction or y-direction once per revolution during the rotation of the X-ray rotating anode). This is described in the following calculation using a line profile running in the radial direction along the focal path surface, which can be obtained as described in No. 3 below. For the following calculation, it is assumed that the radial direction is simultaneously aligned in the X-ray emission direction or y-direction.
3. With regard to the line profiles to be created in the radial directions: Due to the rotational symmetry of the X-ray rotating anode, the image points/pixels of the captured 3-dimensional height profile typically do not lie exactly along the respective radial direction, so that in order to generate the line profiles running in this direction, a corresponding approximation to the captured surface structure (e.g. by means of a fitted height profile running along the captured image points/pixels) must be carried out in order to create a line profile for all y-coordinates. This means that in order to generate the line profiles running in this direction, a corresponding approximation of the recorded surface structure (e.g. by means of a fitted height profile running along the recorded image points/pixels) must be carried out in order to obtain corresponding z values (i.e. heights) for all y coordinates (or radial coordinates) along the line profile. This determination of the line profiles running in the radial direction is preferably carried out with software support, e.g. using a fitting function.
4. To simplify matters, only the radiation power of each generation point of the line profile used as an example is determined strictly in the direction of the radial direction, which is assumed in the present case to be aligned in the X-ray emission direction or y-direction, and not for each generation point initially a cone-shaped radiation emitted in the area around the X-ray emission direction, in order to then sum up or integrate the radiation emitted exactly in the X-ray emission direction across the generation points. This enables the calculation using line profiles, as explained in detail below.
5. Furthermore, regardless of the generation point and the surface structures present locally at the generation point along the X-ray emission direction, it is assumed that the emitted X-rays travel a minimum path length in the focal path material. Depending on the angle of inclination (in this case: α=10°), this minimum path length is to be selected as a fraction of the path length of the locally emitted radiation through the focal path material to be expected for a smooth surface, e.g. 5 μm for an expected path length of 9.07 μm (this is an example for an angle of inclination of the focal path of) α=10°. Due to the special features of the 3-dimensional height profile and its resolution, this avoids theoretically possible peaks in the radiation power emitted locally from individual generation points, which would lead to local distortions (e.g. on flanks of the surface structure of the focal path surface that slope very steeply in the X-ray emission direction).

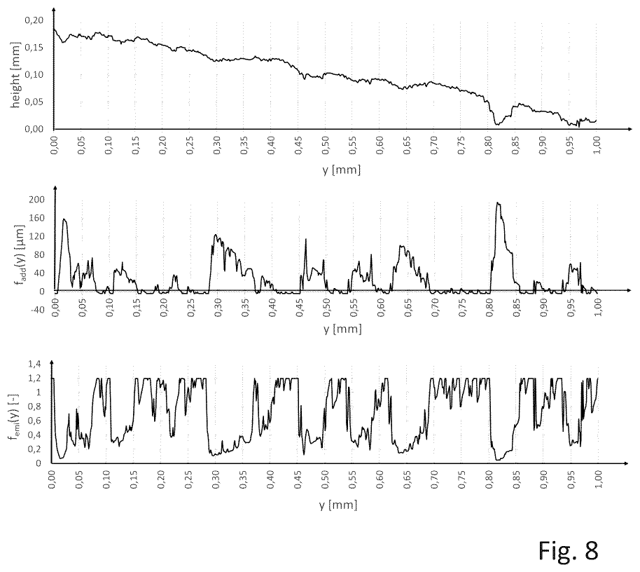

With reference to FIGS. 6, 7 and 8, it is explained below how the absorption by the focal track material is determined for each point of generation of X-rays, taking into account the local surface modifications according to the 3-dimensional height profile: In FIG. 8, the top diagram shows an exemplary line profile of a used focal path surface, plotted as height (unit: millimetres) (see “height [mm]” in the diagram) over the y-direction (unit: millimetres) (see “y [mm]” in the diagram). It can be generated, for example, from a section of the 3-dimensional height profile shown in FIG. 5 along the X-ray emission direction y. FIGS. 6 and 7 each show a schematic section of such line profiles of focal path surfaces. In FIG. 6, the situation of a perfectly smooth focal path surface 92, which is inclined at an angle of inclination α=10° (shown larger in FIGS. 6 and 7 for illustration purposes) relative to the y direction, is shown first. Using two exemplary electrons 94, 96, which impinge on the focal path surface 92 with two different y-coordinates and (simplified) penetrate to the respective generation point 98 in accordance with the mean generation depth dₑ₋ of X-rays, the path length d_{x-ray} travelled by the generated X-rays in the X-ray emission direction (y-direction) through the focal path material is shown. Regardless of where the electrons appear within the focal spot, the path length travelled can be determined using the following formula:

$${d}_{x - ray} = \frac{{d}_{e -}}{tan ( α )} \qquad ( 1 )$$

With dₑ₋=1.6 μm and α=10°, this results in a constant “theoretical path length” travelled d_{x-ray}=9.07 μm. This means that with a perfectly smooth focal path surface 92, the generated X-rays are first filtered through the focal path material over a path length d_{x-ray} of a constant 9.07 μm before they emerge from the focal path surface. It is then filtered through filter 102 before it hits a detector 104 (if there are no other obstacles or objects to be transmitted in the radiation path). For example, a filter made of borosilicate glass with a thickness of 2.5 mm (e.g. as an exit window) and an aluminium filter with a thickness of 2 mm can be used in the calculation model. With regard to filtering by the focal path material, filtering by pure tungsten (W) can be used for simplification in relation to tungsten-rhenium focal paths (with a predominant proportion of tungsten), as tungsten (W) and rhenium (Re) differ only slightly in their atomic number and density. The absorption by the focal path material (over a path length of 9.07 μm in each case) occurring with a perfectly smooth focal path surface and the filtering by the filters 102 is referred to as basic filtering.

The potential base radiation power of a line profile or a y-coordinate to be expected with such a perfectly smooth focal path surface is used as a reference value. In particular, based on the initial spectrum described above, the absorption by the focal path material over the path length of 9.07 μm and the filtering by the filters 102, the potential base radiation power to be expected for a single y-coordinate in the X-ray emission direction is first determined. This is done in particular with software support (e.g. with SpekCalc pro 1.1, a software developed by Gavin Poludniowski and Phil Evans at “The Institute of Cancer Research”, London, UK with regard to the theoretical approach and by Francois deBlois, Guillaume Landry and Frank Verhaegen at Mc Gill University, Montreal, Canada with regard to the graphical user interface; currently available at www.spekcalc.weebly.com). The software is preferably set up in such a way that it first determines the reduction/filtering of the initial spectrum for a single y-coordinate of the line profile (wavelength-dependent) (since the strength of the reduction/filtering is dependent on the wavelength or energy of the photons) in order to obtain a “potential base spectrum” (“potential”, since the electron intensity distribution and size of the focal spot are not yet taken into account), the intensity distribution of which is reduced compared to the initial spectrum (wavelength-dependent). A “potential base radiation power” is then preferably determined for a single y-coordinate, which results from the sum or integration of the radiation powers over the various wavelengths of the potential base spectrum obtained after base filtering. Since a perfectly smooth focal path surface is assumed here and only the “potential” base spectrum and the “potential” base radiation power are considered (i.e., the electron intensity distribution and size of the focal spot have not yet been taken into account), these are constant over the different y-coordinates of a line profile and correspondingly also in the circumferential direction for different line profiles.

In contrast, the focal path surface of FIG. 7 has surface structures or surface modifications 100, as they occur, for example, in a used X-ray rotating anode (otherwise FIG. 7 is structured in the same way as FIG. 6 and the same components/sections are labelled with the same reference signs). According to the calculation model, the actual path length d′_{x-ray} (in the y-direction) travelled by the focal path material is now determined for each generation point 98 of X-rays, i.e. for each y-coordinate along the y-direction (X-ray emission direction) of the line profile, taking into account the surface modifications according to the 3-dimensional height profile, as illustrated in FIG. 7. To determine this “actual path length” d′x-ray, partial path lengths may also have to be added if the X-rays initially exit the focal path surface from a generation point in the y-direction, but then enter the focal path material again (e.g. due to a localised elevation) (once or several times) before finally reaching the free area outside the focal path material. This determination and the other calculation steps (unless otherwise specified) are preferably carried out with software support using appropriately configured software (e.g. Matlab R2017b 64 bit; currently available at www.mathworks.com). For this purpose, the respective line profile (as shown, for example, in FIG. 8 in the top diagram) is preferably imported into the software. Alternatively, one or more 3-dimensional height profile(s) are imported into the software and then the line profiles running in a radial direction are generated according to the above simplification/approach no. 3. Furthermore, the angle of inclination (here: α=10°) and the average generation depth of X-rays (here: dₑ₋=1.6 μm) must be taken as a basis in order to then determine, as illustrated in FIG. 7, the actual path length d′_{x-ray} for each y-coordinate of the respective line profile starting from the respective associated generation point (offset by dₑ₋ in the z-direction downwards into the focal path material) and travelled in the y-direction through the focal path material. This can be done using the software, for example, by comparing the original line profile (decisive for the focal path surface) and a line profile that is offset by dₑ₋ in the z-direction downwards into the focal path material and is otherwise identical (decisive for the generation point), in order to then determine the actual path lengths travelled in the y-direction as a function of the respective y-coordinate of the respective line profile. An additional path length distribution f_{add}(y) is then determined by subtracting the theoretical path length d_{x-ray} from the actual path length d′_{x-ray}(y) as follows:

f_{add}(y)=d′_{x-ray}(y)−d_{x-ray} if d′_{x-ray}(y)≤5 μm:f_{add}(y):=5 μm−9.07 μm=−4.07 μm (2)

If the actual path length d′_{x-ray} (y) for a y-coordinate deviates from the theoretical path length d_{x-ray}, this results in an actual filtering that differs from the basic filtering explained above. Surface modifications that occur result in an increased actual path length d′_{x-ray} (y) for most y-coordinates compared to the theoretical path length d_{x-ray} (i.e. values >0 for f_{add}). For a certain proportion of the y-coordinates, however, the actual path length d′_{x-ray} (y) is reduced (i.e. values <0 for f_{add}), in which case at least the minimum path length of 5 μm must be used in accordance with the above simplification/approach no. 5 (see line 2 of equation (2)). In FIG. 8, the second diagram shows the additional path length distribution, plotted as the additional path length f_{add}(y) (unit: micrometre or μm) (“f_{add}(y) [μm]” in the diagram) over the y-direction (unit: millimetre) (see “y [mm]” in the diagram), which results specifically for the line profile shown in FIG. 8 above.

Then, largely as for the perfectly smooth focal path (preferably software-supported, e.g. with SpekCalc pro 1.1; see above), the (wavelength-dependent) reduction/filtering of the initial spectrum is first determined as a function of f_{add} (and not yet specifically for different y-coordinates) in order to obtain a “potential actual spectrum” as a function of f_{add}, the intensity distribution of which is reduced compared to the initial spectrum. A “potential actual radiation power”, which results from the sum or integration of the radiation powers over the various wavelengths of the potential actual spectrum, is then determined as a function of f_{add}. As a further step, the ratio f_{red} of this potential actual radiation power relative to the potential base radiation power (determined as specified above) is formed as a function of f_{add} (preferably again with software support, e.g. with SpekCalc pro 1.1; see above). This determined ratio f_{red} (f_{add}) therefore indicates the extent to which the potential actual radiation power of a point of origin of X-rays changes relative to the potential base radiation power of a perfectly smooth focal path surface as a function of the additional path length f_{add} that the X-rays have to travel from the point of origin. This determined ratio f_{red} (f_{add}) can be fitted in particular with a function, preferably with a double exponential function (i.e., by means of a sum of two exponential functions). Starting from the minimum value (in this case −4.07 μm), it is greater than 1 for negative values of the additional path length f_{add}, then falls continuously and reaches exactly the value 1 for f_{add}=0. For positive values of the additional path length f_{add}, it is less than 1 and approaches zero for increasingly larger values of the additional path length f_{add}. This function is now applied, preferably again with software support (e.g. with Matlab R2017b 64 bit; see above), specifically to the additional path length distribution f_{add}(y), as determined for the line profile using equation (2), in order to obtain an emission distribution fₑₘᵢ(y) over the various y-coordinates of the line profile, as shown below in equation (3):

fₑₘᵢ(y)=f_{red}(fada(y)) (3)

The emission distribution fₑₘᵢ(y) indicates the ratio of the potential actual radiation power relative to the potential base radiation power for the various y-coordinates of the line profile, whereby this ratio is greater than 1 for y-coordinates with an associated negative value of f_{add}(i.e. d′_{x-ray} (y)<d_{x-ray}) and less than 1 for positive values of f_{add}(i.e. d′_{x-ray} (y)>d_{x-ray}). This means that the greater the actual path length d′_{x-ray} is in relation to the theoretical path length d_{x-ray} for the respective generation point, the lower the ratio of the potential actual radiation power relative to the potential base radiation power (i.e., the more emitted radiation is absorbed), and vice versa. In FIG. 8, this ratio or this emission distribution is shown in the third diagram, plotted as the emission distribution fₑₘᵢ(y) (“fₑₘᵢ(y)[−]” in the diagram) over the y-direction (unit: millimetres) (see “y [mm]” in the diagram), which results specifically for the additional path length f_{add}(y) shown in FIG. 8 in the second diagram.

Finally, the electron intensity distribution in the y-direction (i.e., along the radial direction) must also be taken into account in order to compare quantities that are not only designated as “potential”, since the radiation power generated at the respective y-coordinate depends on whether and with what intensity electrons impinge on this y-coordinate. For this reason, for example, damage to the focal path surface in the radial direction outside the focal spot area is less critical, as no X-rays are generated at these positions, whereas damage in the area of high electron intensity can be particularly critical, especially if it leads to strong shadowing. As explained under simplification/approach no. 2 above, the electron intensity distribution in X-ray rotating anodes can be described by a linear (in y-direction or radial direction) intensity profile fₑ₋ (y). The emission distribution fₑₘᵢ(y) is to be weighted accordingly by this intensity profile fₑ₋ (y) in order to obtain the ratio O(y) of the “actual radiation power” relative to the “base radiation power” for the respective y-coordinate, as shown in the equation below:

O(y)=fₑ₋ (y)*fₑₘᵢ(y) (4)

To then obtain the ratio O_{Linie} of the actual radiation power emitted over the entire line profile of a damaged focal path surface with surface structures relative to the corresponding base radiation power that would be emitted over the entire line profile in the case of a perfectly smooth focal path surface, O(y) must be integrated over the y-coordinate, as shown by the equation below:

O_{Linie}=∫fₑ₋ (y)*fₑₘᵢ(y)dy (5)

In this way, the effects of surface structures that occur in the area of a specifically analysed line profile of a damaged focal path surface on the emitted radiation power can be evaluated. In particular, O_{Linie} represents a characteristic value for the attenuation of the radiation power due to damage to the focal path surface. Furthermore, a large number of line profiles (each running radially and preferably distributed in the circumferential direction around the X-ray anode) can of course be analysed in a corresponding manner. On the one hand, variations that can occur in the circumferential direction of the X-ray rotating anode can be determined. Furthermore, a total radiation power can also be determined by summing up/integrating the O_{Linie} values obtained for the individual line profiles.

The present invention is not limited to the embodiments described. For example, as an alternative to the simplification/approach No. 2 (see above), an electron intensity distribution over the affected area, i.e. a function fₑ₋ (x,y), can also be used with regard to the focal spot and the line profile. Then, depending on the size of the focal spot, a number of adjacent line profiles of the 3-dimensional height profile must be included and, finally, the resulting emissivity distribution fₑₘᵢ(x,y) must be weighted by scalar multiplication with the electron intensity distribution fₑ₋ (x,y). Several such surface sections in the circumferential direction of the focal path are then preferably analysed in the same way.

1-15. (canceled)

16. An X-ray rotating anode analyzing system for analyzing a used X-ray rotating anode having a circumferential focal path at a surface portion thereof, the system comprising:
a positioning device for the X-ray rotating anode;
an image recorder; and
a data processor coupled to the image recorder,
the positioning device and the image recorder being configured such that the X-ray rotating anode can be positioned as an individual component at a predetermined position relative to the image recorder;
the image recorder and the data processor being configured to detect a 3-dimensional height profile of a surface section of the X-ray rotating anode in a region of the focal path; and
the data processor being configured to determine, from at least a part of the recorded 3-dimensional height profile, a radiation power to be expected or a value of the X-ray rotating anode.

17. The X-ray rotating anode analysis system according to claim 16, wherein the image recorder and the data processor are configured to:
produce, using electromagnetic radiation, a plurality of individual images with respectively different depth information of a surface section of the X-ray rotating anode to be analysed; and
reconstruct a 3-dimensional height profile of the surface section to be analysed from the individual images.

18. The X-ray rotating anode analysis system according to claim 17, wherein the image recorder and the data processor are configured to produce, from different angles, a plurality of individual images of the surface section to be analysed using electromagnetic radiation in the wavelength range of 380 nm-780 nm.

19. The X-ray rotating anode analysis system according claim 16, wherein the data processor is configured to determine the radiation power to be expected or a characteristic value of the X-ray rotating anode based on an automatically calculated absorption of X-rays along an X-ray emission direction, taking into account local absorption effects due to local surface modifications according to the recorded 3-dimensional height profile.

20. The X-ray rotating anode analysis system according to claim 19, wherein the data processor is configured to use at least one line profile, which extends in the X-ray emission direction over a predetermined minimum length along the detected surface section of the X-ray rotating anode and has local surface modifications according to the 3-dimensional height profile, for the automated calculation of the absorption of X-rays.

21. The X-ray rotating anode analysis system according to claim 19, wherein the data processor is configured to use at least one surface profile which extends in the X-ray emission direction over a predetermined minimum length and substantially perpendicularly thereto over a predetermined minimum width along the detected surface section and has local surface modifications according to the 3-dimensional height profile for the automated calculation of the absorption of X-rays.

22. The X-ray rotating anode analysis system according to claim 19, wherein the data processor is configured to include at least one input value in the automated calculation of the absorption of X-rays, the at least one input value being selected from the group consisting of:
generation depth of X-rays;
X-ray emission angle;
material of the focal path of the X-ray rotating anode;
size of the focal spot;
electron intensity distribution of the focal spot; and
filter.

23. The X-ray rotating anode analysis system according to claim 16, the data processor is configured to identify and categorize, from the recorded 3-dimensional height profile or from an otherwise recorded image information of a surface section of the focal path, damage to the focal path of the X-ray rotating anode in a region of the surface section.

24. The X-ray rotating anode analysis system according to claim 16, wherein the image recorder and the data processor are configured to record at least one image recording of a further surface section of the X-ray rotating anode in a region next to the focal path can be recorded.

25. The X-ray rotating anode analysis system according to claim 16, wherein the data processor is configured to evaluate further usage options of the X-ray rotating anode based on the determined expected radiation power or a characteristic value for the determined expected radiation power, and a corresponding usage recommendation can be issued.

26. The X-ray rotating anode analysis system according to claim 16, wherein the data processor is coupled to a memory, and the data processor and the memory are configured to:
store information determined individually for the respective analysed X-ray rotating anode in the memory by the data processor and read out the stored information from the memory;
store type-specific information for different types of X-ray rotating anodes in the memory by the data processor and read out stored type-specific information from the memory;
store operating data recorded individually for the respective analysed X-ray rotating anode in the memory by the data processor and read out the stored operating data from the memory; and
store individual history of the respective analysed X-ray rotating anodes regarding their use in the field and regarding revisions and modifications made to them in the memory and read out the stored individual history from the memory.

27. The X-ray rotating anode analysis system according to claim 25, wherein the data processor is configured to include at least one of the following further pieces of information in the evaluation of the further use options of the X-ray rotating anode:
homogeneity of the 3-dimensional height profile along a circumferential direction of the X-ray rotating anode;
damage to the focal path of the X-ray rotating anode in the area of the surface section;
image of a further surface section of the X-ray rotating anode in the area next to its focal path;
geometric changes in the X-ray rotating anode;
information determined individually for the respective analysed X-ray rotating anode;
type-specific information for the respective analysed X-ray rotating anode;
individually recorded operating data for the respective analysed X-ray rotating anode; and
individual history of the analysed X-ray anode.

28. The X-ray rotation analysis system according to claim 16, wherein the X-ray rotation anode is configured as an individual component in the positioning device.

29. A method of analyzing a used X-ray rotating anode having a circumferential focal path at a surface portion thereof, the method comprising:
positioning the X-ray rotating anode as an individual component with the aid of a positioning device relative to an image recorder;
acquiring a 3-dimensional height profile of a surface section of the X-ray rotating anode in the region of its focal path by the image recorder and by a data processor coupled to the image recorder; and
automatically determining, by the data processor, an expected radiation power or a characteristic value of the X-ray rotating anode from the recorded 3-dimensional height profile or from a part thereof.
